(19) United States
(12) Patent Application Publication
(10) Pub. No.: US 2018/0351895 A1
(43) Pub. Date: Dec. 6, 2018

(54) In the event of selection of message, invoking camera to enabling to capture media and relating, attaching, integrating, overlay message with/on/in captured media and send to message sender

(71) Applicant: Yogesh Rathod, Mumbai (IN)

(72) Inventor: Yogesh Rathod, Mumbai (IN)

(21) Appl. No.: 16/032,171

(22) Filed: Jul. 11, 2018

Related U.S. Application Data
(63) Continuation of application No. PCT/IB2018/055090, filed on Jul. 11, 2018.

(51) Int. Cl. H04L 12/58; A63F 13/213; A63F 13/31; G06F 9/54

(52) U.S. Cl. CPC H04L 51/10; A63F 13/213; H04L 2463/121; G06F 9/54; A63F 2300/69; A63F 13/31

(57) ABSTRACT

A system and a method for playing a photo or video based game are provided. The method includes establishing a communication link between a game playing system and one or more game playing devices, each of which is operated by a respective player. Game rules are presented to the player(s) on the respective game playing device(s). The game rules include at least one task for the submission of at least one photographic image or video or media. Provision is made for receiving a photographic image or video or media in the game playing system which has been submitted via the established link from the game playing device in response to the presented task. A system and a method for sending and displaying a message, from a first computing device of a first user, to one or more target recipients including the second user of the second computing device and enabling the receiving user including the second user of the second computing device to accept or reject the message. In an embodiment enabling receiving user to capture a photo or record a video or take one or more types of media, associating or relating said captured photo or recorded video or media with particular selected and accepted message. In an embodiment enabling the receiving user including the second user of the second computing device to select particular received and accepted message and in the event of selection of particular received and accepted message, displaying camera application to capture photo or record video or take one or more types of media and automatically associating or relating said captured photo or recorded video or media with said accepted or selected message. In an embodiment enabling the receiving user to select particular received and accepted message and in the event of selection of particular received and accepted message, displaying camera application to enabling to capture photo or record video or take one or more types of media and automatically integrating or attaching or embedding or overlay said accepted or selected message or message with particular pre-set number of characters or identified or determined keywords inside message with/on/in said captured photo or recorded video or media. In the event of receiving instruction to send, from the second user of the second computing device, sending said captured photo or recorded video or media to the first computing device of the first user or the message sender; and displaying said captured photo or recorded video or media to the first computing device of the first user or the message sender.

In the event of selection of message, invoking camera to enabling to capture media and relating, attaching, integrating, overlay message with/on/in captured media and send to message sender

### FIELD OF INVENTION

A system and a method for playing a photo or video based game are provided. The method includes establishing a communication link between a game playing system and one or more game playing devices, each of which is operated by a respective player. Game rules are presented to the player(s) on the respective game playing device(s). The game rules include at least one task for the submission of at least one photographic image or video or media. Provision is made for receiving a photographic image or video or media in the game playing system which has been submitted via the established link from the game playing device in response to the presented task. A system and a method for sending and displaying a message, from a first computing device of a first user, to one or more target recipients including the second user of the second computing device and enabling the receiving user including the second user of the second computing device to accept or reject the message. In an embodiment enabling receiving user to capture a photo or record a video or take one or more types of media, associating or relating said captured photo or recorded video or media with particular selected and accepted message. In an embodiment enabling the receiving user including the second user of the second computing device to select particular received and accepted message and in the event of selection of particular received and accepted message, displaying camera application to capture photo or record video or take one or more types of media and automatically associating or relating said captured photo or recorded video or media with said accepted or selected message. In an embodiment enabling the receiving user to select particular received and accepted message and in the event of selection of particular received and accepted message, displaying camera application to enabling to capture photo or record video or take one or more types of media and automatically integrating or attaching or embedding or overlay said accepted or selected message or message with particular pre-set number of characters or identified or determined keywords inside message with/on/in said captured photo or recorded video or media. In the event of receiving instruction to send, from the second user of the second computing device, sending said captured photo or recorded video or media to the first computing device of the first user or the message sender; and displaying said captured photo or recorded video or media to the first computing device of the first user or the message sender.

### BACKGROUND OF THE INVENTION

U.S. Pat. No. 8,813,111 of et el Guerin Nicolas (Title: Photograph-based game) discloses a system and a method for playing a photograph-based game are provided. The method includes establishing a communication link between a game playing system and one or more game playing devices, each of which is operated by a respective player. Game rules are presented to the player(s) on the respective game playing device(s). The game rules include at least one task for the submission of at least one photographic image. Provision is made for receiving a photographic image in the game playing system which has been submitted via the established link from the game playing device in response to the presented task. An image signature is computed for the submitted photographic image based on visual features extracted from the image and a relevance to the task is computed, based on the computed image signature. A score for the game is output for each player, based on the computed relevance of the submitted images for each of the tasks. U.S. Pat. No. 8,813,111 of et el Guerin Nicolas (Title: Photograph-based game) also discloses a method for playing a photograph-based game comprising: establishing a communication link between a game playing system and at least one game playing device which is operated by a player; providing for presenting of game rules to the player on the at least one game playing device, the game rules including a plurality of tasks for the submission of at least one photographic image that is relevant to a category, the tasks being presented sequentially; for each of the tasks: providing for receiving a photographic image in the game playing system submitted via the established link from the game playing device; computing an image signature for the submitted photographic image, the image signature comprising a multidimensional vector or graph which is a statistical representation of visual features extracted from patches of the photographic image; and computing a relevance to the task, based on the computed image signature, the computing of the relevance to the task comprising classifying the image signature with a pretrained classifier model that has been trained on a training set of image signatures and respective labels, the training set of image signatures including image signatures computed for images that are labeled as relevant to the category; and presenting a score to the player based on the computed relevance for the task before presenting a next of the tasks.

Present invention discloses a system and method for playing a photo or video or media based game comprising: establishing a communication link between a game playing system and a first computing device of a first user and a second computing device of a second user or at least two game playing device which is operated by a player. The first computing device of the first user providing for presenting of game rules to the player on the second computing device of the second user or at least one game playing device, the game rules including a one or more tasks for the submission of at least one photo or image or video or media that is relevant to a message or request or suggestion or instruction send by the first computing device of the first user; for each of the tasks or message or request or suggestion or instruction: providing for receiving a photographic image or video or media in the game playing system submitted via the established link from the game playing device or from the second computing device of the second user; the game playing system presenting said received task or message or request or suggestion specific photographic image or video or media to the first computing device of the first user or the device of the message sender or requestor or instructor or suggestion provider. In an embodiment the second computing device of the second user can accept or reject received message or request or suggestion or instruction to do particular task including take message or request or suggestion or instruction specific photo or video or media. In an embodiment the first computing device of the first user can review, verify or check received message or request or suggestion or instruction specific photo or video or media from the second computing device of the second user and accept or reject it based on human mediated actions. Present invention enables user to user providing instruction or task to capture message or instruction or request or suggestion particular specific photo or video or media to other users and providing captured photo or recorded video to other users based on received and accepted message or instruction or request or suggestion. Receiving user of captured photo or recorded video can manually review, check, verify and validate received captured photo or recorded video to determine whether received captured photo or recorded video is as per message or instruction or request or suggestion or not. If received captured photo or recorded video is as per message or instruction or request or suggestion then accepts it and system may add points to accounts of sender of photo or recorded video. If received captured photo or recorded video is not as per message or instruction or request or suggestion then rejects it and system may deducting points from accounts of sender of photo or recorded video.

Aspects of the exemplary embodiment relate to a system and method for playing a game and find particular application in connection with a photo or video or media based game in which facilitating message or request or instruction or suggestion receiving user to select particular received and accepted message or request or instruction or suggestion from lists of received and accepted messages or requests or instructions or suggestions and in the event of selection of particular received and accepted message or request or instruction or suggestion, automatically presenting camera application to enable to capture photo or record video or take one or more types of media and automatically associate and relate or attach or integrate said captured photo or recorded video or media with said selected particular received and accepted message or request or instruction or suggestion and enabling user to send to said selected particular received and accepted message or request or instruction or suggestion sender, wherein said received message or request or instruction or suggestion specific captured photo or video or image are assessed, analyzed, verified, check, validate by human or receiving user, based on their compliance with a task provided in the game, using an human mediated action and enabled to accept or reject and notifies to sender of said message or request or instruction or suggestion specific captured photo or video or image.

### OBJECT OF THE INVENTION

The principal object of the present invention is to enabling the first computing device of the first user to send message to the second computing device of the second user and enabling the second computing device of the second user to capture photo or record video as per said received message associate configuration or requirement specification or request or suggestion or instruction or rules or task specific photo or video and enable to manually or automatically associate or relate said captured photo or recorded video with said received message and send to said message sender for verification or validation or checking or analyzing or reviewing whether said photo or video is as per said message associated configuration or requirement specification or request or suggestion or instruction or not and enable to accept or reject said received photo or video and notifies said photo or video sender about acceptance or rejection of photo or video.

The other object of the present invention is to enabling the first computing device of the first user to send message to the second computing device of the second user and enabling the second computing device of the second user to capture photo or record video as per said received message associate configuration or requirement specification or request or suggestion or instruction or rules or task specific photo or video and enable to manually or automatically integrating or combining or merging or embedding or attaching or overlay on/in/with/to/at/within/inside said captured photo or recorded video with said received message or part of message, wherein part of message identified and determined manually by user or automatically by system or server and send to said message sender for verification or validation or checking or analyzing or reviewing whether said photo or video is as per said message associated configuration or requirement specification or request or suggestion or instruction or not and enable to accept or reject said received photo or video and notifies said photo or video sender about acceptance or rejection of photo or video.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” posted or shared contents & communication and any types of multimedia contents from a device or component includes receiving the shared or posted contents & communication and any types of multimedia contents indirectly, such as when forwarded by one or more other devices or components. Similarly, “sending” shared contents & communication and any types of multimedia contents to a device or component includes sending the shared contents & communication and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Embodiments described herein sending a task message and associated rules, settings, metadata and identity of sender, from a first computing device of a first user, to one or more target recipients including the second user of the second computing device; displaying said task message to each said target recipient including the second user of the second computing device; enabling the receiving user including the second user of the second computing device to select particular received and accepted task message; in the event of selection of particular received and accepted task message, automatically displaying camera application to enabling receiving user including the second user of the second computing device to capture photo or record video or take one or more types of media; in the event of capturing of photo or recording of video or taking one or more types of media, automatically associating or relating said captured photo or recorded video or media with said accepted or selected task message; in the event of receiving instruction to send, from the second user of the second computing device, generating a message and receiving, from a second computing device of the second user, said generated message for sending to the task message sender, wherein message comprise said captured photo or recorded video or media and associated metadata and system data; identifying, by a computer processor, the sender of message as recipient of the message; sending said captured photo or recorded video or media to the first computing device of the first user or the message sender; and displaying said captured photo or recorded video or media to the first computing device of the first user or the message sender.

In an embodiment in the event of capturing of photo or recording of video or taking one or more types of media, enabling to manually or automatically integrating or merging or attaching or embedding or overlay said accepted or selected message or part of message or edited message or user provided or selected or applied text or one or more images or geo-filters or one or more types of multimedia with/on/in/within/inside/overlay on said captured photo or recorded video or media.

In an embodiment instructing instructed user to send message within particular duration after instruction or task message specific capturing of photo or recording of video else cancel sending of said captured photo or recorded video to instruction or task message sender, wherein start timer and in the event of expiration of said started timer cancel said captured photo or recorded video for sending to message sender and display camera application to enable to further take or capture photo or record video.

In an embodiment enabling the receiving user including the second user of the second computing device to accept or reject the message.

In an embodiment identifying EXIF data in captured photo or recorded video including original date & time of captured photo or recorded video and match said extracted or identified original date & time with server date & time to validate or check or verify originality of captured photo or recorded video.

In an embodiment in the event of capturing of photo or recording of video or taking one or more types of media, associating or relating said captured photo or recorded video or media with said accepted or selected message.

In an embodiment store prepared, send and received message and associated rules, status and metadata.

In an embodiment store captured or recorded, send and received photo, video, media and associated status, reactions, statistics and metadata.

In an embodiment removing received message after expiration of pre-set duration which starts from when message received.

In an embodiment removing received photo, video or media after expiration of pre-set duration which starts from when photo, video or media received.

In an embodiment sending message with associated one or more rules, preferences and settings and metadata to one or more target recipients.

In an embodiment rules may comprise time limit for photo or image or video or media capture, presenting information for identifying an object to be photographed as the task, wherein the object comprises at least one of a particular named or type of product or item, a location or place or point of interest, an particular named or type of infrastructure including building, shop, mall, and road, a particular named or type of bird and animal, a particular named or type of logo or brand or company, a person or particular named one or more contacts, a particular named or type of event including sport event, conference, and combinations thereof.

In an embodiment displaying said message and associated one or more rules, preferences and settings and metadata to each said target recipient.

In an embodiment sending said captured photo or recorded video with associated metadata to said message sender.

In an embodiment displaying said captured photo or recorded video with associated metadata to said message sender.

In an embodiment the game rules require the submitted photographic image or video or media to have an integrated and encrypted date stamp in the form of exchangeable image file format (EXIF) data which is matched with captures photo or image or recorded video or media date and time with server date and time.

In an embodiment enabling to accept or select notification of received message or particular received and accepted message and in the event of selection of notification of received message or particular received and accepted message, displaying camera to enable to receiving user to capture photo or record video or take one or more types of media

In an embodiment enable message sender to accept or reject said received or displayed captured photo or recorded video.

In an embodiment enable to prepare or select or auto select or set or configure structured or un-structured message and associate rules, preferences and settings.

In an embodiment in the event of acceptance of received captured photo or recorded video, add points to said photo or video sender's account.

In an embodiment in the event of rejection of received captured photo or recorded video, deduct points to said photo or video sender's account.

In an embodiment message comprise instruction to do particular task and associated one or more rules, wherein instruction to do particular task comprise capture instructed photo or record instructed video.

In an embodiment rules comprise instruction to do particular task within particular duration, must capture at particular location or place, must capture at particular date and time or within particular range of date and time, must contains or includes or excludes particular one or more types or named objects, items, accessories, attributes, properties, characteristics, design, physical environment including sunset or sunrise, rain, sunrays, day or night or evening, buildings or infrastructure, trees, animals, birds, persons or entities, brands, logos, products and like.

In an embodiment enable to prepare message from one or more types of structured or unstructured templates including templates provided by server, templates directories, categories templates including templates based on levels, search and match templates base on search query, boolean operators, conditions, criteria, selections, filters, settings, and advance search options, suggested templets based on one or more types of user data and connected user data or selected user to whom user wants to send message, wherein user data may comprises user profile like age, gender, current or past or home or office locations and places, education, skills, income range, related type or named entities including school, college, company, user logged activates, actions, events, transactions, status, senses, behaviours, updates, locations, places, communications, sharing and any combination thereof, public templates shared or allowed to access by uses of network, templates provided by advertisers, sponsors, contacts of user, contacts of contacts of user, past templates of user.

In an embodiment metadata with message comprises identity of sender of message, identity of receiver message, date & time of message send, pre-set maximum duration to capture and send instructed media by message receiver.

In an embodiment metadata with captured photo or recorded video comprises identity of message and associated message, identity of sender of photo or video, identity of receiver of photo or video, ephemeral or non-ephemeral settings, pre-set view duration, date & time of capturing of photo or recording of video.

In an embodiment recipients comprises all or one or more selected or included or excluded contacts, groups, networks, contacts of contacts, categories of users of network, pre-defined or query or SQL (Structured Query Language) query based users of network, followers, phone contacts, e-mail addresses, social network accounts and any combination thereof.

In an embodiment notifies each said target recipients about receiving of message.

In an embodiment enable message receiver to accept or reject message associate instruction or request to change instruction or instruct to do message associate instruction by message sender or request to provide more duration to full-fill message associate task or instruction.

In an embodiment in the event of acceptance of message associated instruction, display message.

In an embodiment in the event of rejection of message associated instruction, notifies message sender about rejection of message associated instruction.

In an embodiment in the event of selection of particular message, display camera and enable to capture photo or record video or take one or more types of media.

In an embodiment in the event of selection of particular identified message and capturing of photo or recording of video, store and associate said particular identified message with said captured photo or recorded video and associate metadata.

In an embodiment in the event of selection of particular identified message and capturing of photo or recording of video, enable to preview said captured photo or recorded video and associate metadata.

In an embodiment in the event of selection of particular identified message and capturing of photo or recording of video, enable to send said send said captured photo or recorded video with metadata to said message sender.

In an embodiment in the event of sending of said captured photo or recorded video with metadata to said message sender, notifies said message sender about receiving of said message associated photo or video with metadata.

In an embodiment in the event of click or tap on notification or message display associated received photo or video with metadata.

In an embodiment enable receiving or viewing user to accept or reject said displayed or received photo or video.

In an embodiment in the event of rejection of said received photo or recorded video, further instruct said photo or video sender to further send instructed photo or video based on provided or updated one or more rules including pre-set duration to finish instructed task including further send instructed photo or video within said pre-set duration.

In an embodiment enable one or more users to send message collaboratively or in group.

In an embodiment enable message sender to instruct one or more groups or set of users to collaboratively finish message associated instructed task.

In an embodiment enable user create group and to send invitation to one or more users and in the event of acceptance of invitation add invitation accepted user to add to said group.

In an embodiment enable admin user to pre-set rules, number of times allowed to send message to each member of group, block or remove one or more members.

In an embodiment enable to prepare structured message based on one or more types of forms including pre-created forms, custom forms, wizards, application, Graphical User Interfaces (GUIs), webpage, visual Graphical User Interface (GUI), set of controls, one or more types or named fields.

In an embodiment enable user to add or remove or block or report one or more message sender or users or contacts.

In an embodiment structured message comprise type or category of photo or video, location or place details where receiving user of message must have to capture photo or video at said particular location or place, date and time where receiving user of message must have to capture photo or video at particular date and time or within particular range of date and time, must contains or includes or excludes particular one or more types or named objects, items, accessories, attributes, properties, characteristics, design, physical environment including sunset or sunrise, rain, sunrays, day or night or evening, buildings or infrastructure, trees, animals, birds, persons or entities, brands, logos, products, and describe or define particular type of scene that receiving user of message must have to capture photo or video which contains said defined or described scene.

In an embodiment store, monitor, track, process, verify, and validate message before sending to target recipients.

In an embodiment in the event of found message as spam or inappropriate then block or remove message for sending, alerting sender or mark sender as spammer and remove or black or suspend account of sender after alerting particular number of times.

In an embodiment verify, validate, detect and recognized objects in photo or video as per message associated instruction based on object recognition, face and body detection, voice recognition, optical character recognition technologies.

In an embodiment enabling user to share captured photo or recorded video with one or more contacts, contacts of contacts, groups, networks, followers, connected users, add to story or album or one or more types of feed, one or more destinations including social networks, websites, applications, and services or save locally or save remotely or make accessible or viewable or searchable for public.

In an embodiment sending a task message and associated rules, settings, metadata and identity of sender, from a first computing device of a first user, to one or more target recipients including the second user of the second computing device; displaying said task message to each said target recipient including the second user of the second computing device; enabling the receiving user including the second user of the second computing device to select particular received and accepted task message; in the event of selection of particular received and accepted task message, automatically displaying camera application to enabling receiving user including the second user of the second computing device to capture photo or record video or take one or more types of media; in the event of capturing of photo or recording of video or taking one or more types of media, enabling to manually or automatically integrating or merging or attaching or embedding or overlay said accepted or selected message or part of message or edited message or user provided or selected or applied text or one or more images or geo-filters or one or more types of multimedia with/on/in/within/inside/overlay on said captured photo or recorded video or media; in the event of receiving instruction to send, from the second user of the second computing device, generating a message and receiving, from a second computing device of the second user, said generated message for sending to the task message sender, wherein message comprise said captured photo or recorded video or media, integrated text or image or multimedia and associated metadata and system data; identifying, by a computer processor, the sender of message as recipient of the message; sending said captured photo or recorded video or media to the first computing device of the first user or the message sender; and displaying said captured photo or recorded video or media to the first computing device of the first user or the message sender.

In an embodiment sending a message, from a first computing device of a first user, to one or more target recipients including the second user of the second computing device; displaying said message to each said target recipient including the second user of the second computing device; enabling the receiving user including the second user of the second computing device to accept or reject the message; enable the receiving user including the second user of the second computing device to capture a photo or record a video or take one or more types of media; enable the receiving user including the second user of the second computing device to associating or relating said captured photo or recorded video or media with particular selected and accepted message; in the event of receiving instruction to send, from the second user of the second computing device, sending said captured photo or recorded video or media to the first computing device of the first user or the message sender; and displaying said captured photo or recorded video or media to the first computing device of the first user or the message sender.

In an embodiment sending a message, from a first computing device of a first user, to one or more target recipients including the second user of the second computing device; displaying said message to each said target recipient including the second user of the second computing device; enabling, the receiving user including the second user of the second computing device, to view and accept or select received message and in the event of acceptance or selection of received message, displaying camera application to enable receiving user including the second user of the second computing device to capture photo or record video or take one or more types of media; in the event of capturing of photo or recording of video or taking one or more types of media, associating or relating said captured photo or recorded video or media with said accepted or selected message; in the event of receiving instruction to send, from the second user of the second computing device, sending said captured photo or recorded video or media to the first computing device of the first user or the message sender; and displaying said captured photo or recorded video or media to the first computing device of the first user or the message sender.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program. The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a network diagram depicting a network system having a client-server architecture configured for exchanging data over a network implementing various embodiments of enabling to send message including instruction, assign or request or suggest task to one or more target recipients, receive said message specific captured or recorded one or more types of media and relating, associating or attaching or integrating, merging, and overlay message or part of message with/on/in said captured media and send to message sender related system.

FIG. 2 illustrates components of an electronic device implementing various embodiments of enabling to send message including instruction, assign or request or suggest task to one or more target recipients, receive said message specific captured or recorded one or more types of media and relating, associating or attaching or integrating, merging, and overlay message or part of message with/on/in said captured media and send to message sender related system.

FIG. 3 illustrates example Graphical User interface (GUI) for enabling user to prepare, draft, select message, wherein message comprises task description, requirement specification, instruction, request to take said message specific media.

FIGS. 4-5 illustrates example Graphical User interface (GUI) enabling user to view received message, take one or more types of user actions or call-to-actions including accept or reject received message, take media, associate or relate or attach or integrate said media with said received message and send to message sender.

FIG. 6 illustrates example Graphical User interface (GUI) enabling user to view received one or more types of media related to send message, take one or more types of user actions or call-to-actions including accept or reject received media, provide one or more types of reactions.

FIG. 7 illustrates example Graphical User interface (GUI) enabling user to select one or more types of playing mode, send or accept invitations, define or update rules, create, participate in and manage one or more teams and view scores, statistics, status and various types of logs.

FIG. 8 illustrates example Graphical User interface (GUI) enabling user to select, set, apply and update one or more types of privacy settings, preferences, rules and configure and consume one or more types of services.

FIG. 9 illustrates example Graphical User interface (GUI) displaying feed items or one or more types of published contents or media or posts from one or more sources including connected users, followers, members of team, user specific auto matched sources, and preferences specific sources.

FIG. 10 is a block diagram that illustrates a mobile computing device upon which embodiments described herein may be implemented.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

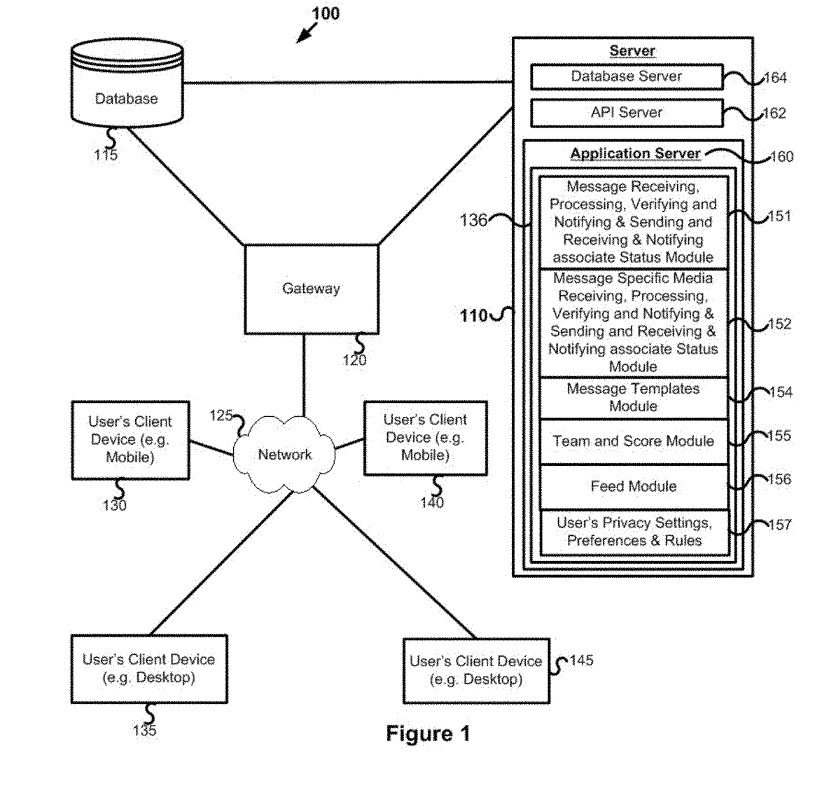

FIG. 1 illustrates an example user to user connection platform, under an embodiment. According to some embodiments, system 100 can be implemented through software that operates on a portable computing device, such as a mobile computing device 110. System 100 can be configured to communicate with one or more network services, databases, objects that coordinate, orchestrate or otherwise provide shared, published, send, receive messages and contents of each user to other users of network. Additionally, the mobile computing device can integrate third-party services which enable further functionality through system 100.

The system for enabling user to user providing and receiving task or instruction and capture and send said task or instruction specific photo or video platform. User can send a message, from a first computing device of a first user, to one or more target recipients including the second user of the second computing device and enabling the receiving user including the second user of the second computing device to accept or reject the message. In an embodiment enabling receiving user to capture a photo or record a video or take one or more types of media, associating or relating said captured photo or recorded video or media with particular selected and accepted message. In an embodiment enabling the receiving user including the second user of the second computing device to select particular received and accepted message and in the event of selection of particular received and accepted message, displaying camera application to capture photo or record video or take one or more types of media and automatically associating or relating said captured photo or recorded video or media with said accepted or selected message. In an embodiment enabling the receiving user to select particular received and accepted message and in the event of selection of particular received and accepted message, displaying camera application to enabling to capture photo or record video or take one or more types of media and automatically integrating or attaching or embedding or overlay said accepted or selected message or message with particular pre-set number of characters or identified or determined keywords inside message with/on/in said captured photo or recorded video or media. In the event of receiving instruction to send, from the second user of the second computing device, sending said captured photo or recorded video or media to the first computing device of the first user or the message sender; and displaying said captured photo or recorded video or media to the first computing device of the first user or the message sender. While FIG. 1 illustrates a gateway 120, a database 115 and a server 110 as separate entities, the illustration is provided for example purposes only and is not meant to limit the configuration of the user to user providing and receiving task or instruction and capture and send said task or instruction specific photo or video system. In some embodiments, gateway 120, database 115 and server 110 may be implemented in the user to user providing and receiving task or instruction and capture and send said task or instruction specific photo or video system as separate systems, a single system, or any combination of systems.

As illustrated in FIG. 1, the user to user providing and receiving task or instruction and capture and send said task or instruction specific photo or video system may include a message sender or task assigner or instruction provider or requesting user device or mobile devices 130/140 and message or task or instruction or request receiver and accepted user device or mobile devices 135/145. Devices or Mobile devices 130/140/135/145 may be particular set number of or an arbitrary number of devices or mobile devices which may be capable of enabling user to prepare message or task or instruction or request, send message or task or instruction or request to server for sending to target recipients and receive said message or task or instruction or request specific photo or video, receive notifications, accept or reject message or task or instruction or request, accept or reject message or task or instruction or request specific photo or video. Each device or mobile device in the set of message or task or instruction or request sending user(s) and message or task or instruction or request specific photo or video receiver user 130/140 and message or task or instruction or request receiver user(s) and message or task or instruction or request specific photo or video sender user device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the user to user providing and receiving task or instruction and capture and send said task or instruction specific photo or video system may include gateway 120. Gateway 120 may be a web gateway which may be configured to communicate with other entities including advertiser, and service providers of the user to user providing and receiving task or instruction and capture and send said task or instruction specific photo or video system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of user to user connection system. In various embodiments, gateway 120 may be connected to database 115 and/or server 110 via a wired or a wireless network connection.

Gateway 120 may be configured to send and receive message or task or instruction or request and message or task or instruction or request specific one or more types of content including photo or video, search results, notifications, shared or published contents, user data, wherein user data comprises user requests, user profile, user connections or contacts, connected users' data, user shared data or contents, user's logs, monitored or tracked information about user's one or more types of activities, actions, events, senses, transactions, status, updates, presence information, locations, check-in places and like to/from mobile devices 130/140/135/145. For example, gateway 120 may be configured to store message or task or instruction or request and message or task or instruction or request specific contents to database 115 for storage.

As another example, gateway 120 may be configured to send or present request specific message or task or instruction or request and message or task or instruction or request specific contents to requestor or target recipients from stored database 115 to mobile devices 130/140/135/145. Gateway 120 may be configured to receive requests from mobile devices 130/140/135/145 for accessing feed items.

For example, gateway 120 may receive a request from a mobile device and may query database 115 with the request for searching and matching request specific users of network and one or more types of contents including photos, videos, posts. Gateway 120 may be configured to inform server 110 of updated data. For example, gateway 120 may be configured to notify server 110 when a new message or task or instruction or request or message or task or instruction or request associated photo or video has been received from a mobile device stored on database 115.

As illustrated in FIG. 1, the user to user providing and receiving task or instruction and capture and send said task or instruction specific photo or video system may include a database, such as database 115. Database 115 may be connected to gateway 120 and server 110 via wired and/or wireless connections. Database 115 may be configured to store a database of registered user's profile, accounts, logged activities, indexes, messages or tasks or instructions or requests for sending to target recipients, message or task or instruction or request associated photo or video for sending to associated message sender, one or more types of user related or associated data, payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, user profile, user data, user account's related data, message or task or instruction or request, message or task or instruction or request associated contents which meet the criteria specified in the request. Database 115 may be configured to communicate with server 110.

As illustrated in FIG. 1, the user to user providing and receiving task or instruction and capture and send said task or instruction specific photo or video system may include a server, such as server 110. Server may be connected to database 115 and gateway 120 via wired and/or wireless connections. As described above, server 110 may be notified, by gateway 120, of new or updated message or task or instruction or request, message or task or instruction or request associated one or more captured photos or recorded videos, user requests including search request and invitations, connection request, user profile, user data, user posted or shared or send contents, user contacts and various types of status stored in database 115.

FIG. 1 illustrates a block diagram of the user to user providing and receiving task or instruction and capture and send said task or instruction specific photo or video system configured to implement the platform where user(s) can send message or task or instruction or request to one or more target recipients and receive from message receiver, message or task or instruction or request specific one or more types of contents including one or more captured photos or recorded videos. While FIG. 1 illustrates a gateway 120, a database 115 and a server 110 as separate entities, the illustration is provided for example purposes only and is not meant to limit the configuration of the user to user providing and receiving task or instruction and capture and send said task or instruction specific photo or video system. In some embodiments, gateway 120, database 115 and server 110 may be implemented in the user to user providing and receiving task or instruction and capture and send said task or instruction specific photo or video system as separate systems, a single system, or any combination of systems.

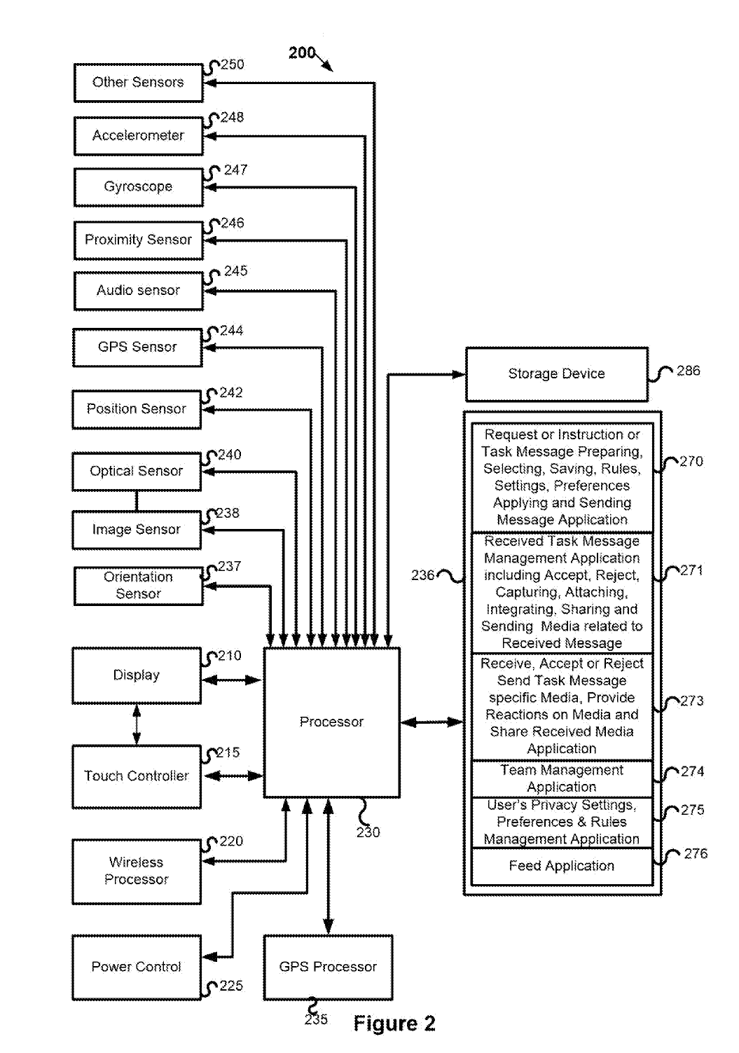

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores Message or Request or Instruction Preparing, Selecting, Saving, Applying Rules, Settings, Preferences and Sending Application (Smart Client or Web based) 270 to implement operations of one of the embodiment of the invention. The Message or Request or Instruction Preparing, Selecting, Saving, Applying Rules, Settings, Preferences and Sending Application (Smart Client or Web based) 270 may include executable instructions to access a client device and/or a server which coordinates operations disclosed herein. Alternately, the Message or Request or Instruction Preparing, Selecting, Saving, Applying Rules, Settings, Preferences and Sending Application (Smart Client or Web based) 270 may include executable instructions to coordinate some of the operations disclosed herein, while the server implements other operations.

The memory 236 stores a Received Message Management including Accept, Reject, Received Message Specific Media Capturing, attaching, Integrating, Sharing and Sending Application (Smart Client or Web based) 271 to implement operations of one of the embodiment of the invention. The Received Message Management including Accept, Reject, Received Message Specific Media Capturing, attaching, Integrating, Sharing and Sending Application (Smart Client or Web based) 271 may include executable instructions to access a client device and/or a server which coordinates operations disclosed herein. Alternately, the Received Message Management including Accept, Reject, Received Message Specific Media Capturing, attaching, Integrating, Sharing and Sending Application (Smart Client or Web based) 271 may include executable instructions to coordinate some of the operations disclosed herein, while the server implements other operations. The memory 236 stores a Send Message Management including Receive Send Message specific Media and Accept or Reject, Provide Reactions and Share Received Media Application (Smart Client or Web based) 273 to implement operations of one of the embodiment of the invention. The Send Message Management including Receive Send Message specific Media and Accept or Reject, Provide Reactions and Share Received Media Application (Smart Client or Web based) 273 may include executable instructions to access a client device and/or a server which coordinates operations disclosed herein. Alternately, the Send Message Management including Receive Send Message specific Media and Accept or Reject, Provide Reactions and Share Received Media Application (Smart Client or Web based) 273 may include executable instructions to coordinate some of the operations disclosed herein, while the server implements other operations. The memory 236 stores a Team Management Application (Smart Client or Web based) 274 to implement operations of one of the embodiment of the invention. The Team Management Application (Smart Client or Web based) 274 may include executable instructions to access a client device and/or a server which coordinates operations disclosed herein. Alternately, the Team Management Application (Smart Client or Web based) 274 may include executable instructions to coordinate some of the operations disclosed herein, while the server implements other operations. The memory 236 stores a Settings, Preferences & Rules Management Application (Smart Client or Web based) 275 to implement operations of one of the embodiment of the invention. The Settings, Preferences & Rules Management Application (Smart Client or Web based) 275 may include executable instructions to access a client device and/or a server which coordinates operations disclosed herein. Alternately, the Settings, Preferences & Rules Management Application (Smart Client or Web based) 275 may include executable instructions to coordinate some of the operations disclosed herein, while the server implements other operations. The memory 236 stores a Feed Application 276 to implement operations of one of the embodiment of the invention. The Feed Application 276 may include executable instructions to access a client device and/or a server which coordinates operations disclosed herein. Alternately, the Feed Application 276 may include executable instructions to coordinate some of the operations disclosed herein, while the server implements other operations.

A touch controller 215 is connected to the display 210 and the processor 230. The touch controller 215 is responsive to haptic signals applied to the display 210.

The electronic device 200 may also include other components commonly associated with a smartphone, such as a wireless signal processor 220 to provide connectivity to a wireless network. A power control circuit 225 and a global positioning system (GPS) processor 235 may also be utilized. While many of the components of FIG. 2 are known in the art, new functionality is achieved through the preparing and sending message and associated rules and settings application 270, and send message associated task related contents application 271 operating in conjunction with a server.

FIG. 2 shows a block diagram illustrating one example embodiment of a mobile device 200. The mobile device 200 includes an optical sensor 240 or image sensor 238, a Global Positioning System (GPS) sensor 244, a position sensor 242, a processor 230, a storage 236, and a display 210.

The optical sensor 240 includes an image sensor 238, such as, a charge-coupled device. The optical sensor 240 captures visual media. The optical sensor 240 can be used to media items such as pictures and videos.

The GPS sensor 244 determines the geolocation of the mobile device 200 and generates geolocation information (e.g., coordinates including latitude, longitude, aptitude). In another embodiment, other sensors may be used to detect a geolocation of the mobile device 200. For example, a WiFi sensor or Bluetooth sensor or Beacons including iBeacons or other accurate indoor or outdoor location determination and identification technologies can be used to determine the geolocation of the mobile device 200.

The position sensor 242 measures a physical position of the mobile device relative to a frame of reference. For example, the position sensor 242 may include a geomagnetic field sensor to determine the direction in which the optical sensor 240 or the image sensor 238 of the mobile device is pointed and an orientation sensor 237 to determine the orientation of the mobile device (e.g., horizontal, vertical etc.).

The processor 230 may be a central processing unit that includes a media capture application 271.

The media capture application 271 includes executable instructions to generate media items such as pictures and videos using the optical sensor 240 or image sensor 238. The media capture application 271 also associates a media item with the geolocation and the position of the mobile device 200 at the time the media item is generated using the GPS sensor 244 and the position sensor 242.

The storage 236 includes a memory that may be or include flash memory, random access memory, any other type of memory accessible by the processor 230, or any suitable combination thereof. The storage 236 stores the media items generated or shared or received by user and also store the corresponding geolocation information, exchangeable image file format (EXIF) data in the case of image files from cameras, smartphones and scanners, auto identified system data including date & time, auto recognized objects in photo or image(s) of video associated keywords, metadata, and user provided information. The storage 236 also stores executable instructions corresponding to Message or Request or Instruction Preparing, Selecting, Saving, Applying Rules, Settings, Preferences and Sending Application (Smart Client or Web based) 270, Received Message Management including Accept, Reject, Received Message Specific Media Capturing, attaching, Integrating, Sharing and Sending Application (Smart Client or Web based) 271, Send Message Management including Receive Send Message specific Media and Accept or Reject, Provide Reactions and Share Received Media Application (Smart Client or Web based) 273, Team Management Application 274, Team Management Application 275 and Feed Application 276.

The display 210 includes, for example, a touch screen display. The display 210 displays the media items generated by the media capture application 271. A user can select received message or task or instruction or request from list of received message or task or instruction or request and capture photo or record video as per received and accepted selected message or task or instruction by touching the corresponding media items on the display 210. A touch controller monitors signals applied to the display 210 to coordinate the capturing, recording, and selection of the media items.

The mobile device 200 also includes a transceiver that interfaces with an antenna. The transceiver may be configured to both transmit and receive cellular network signals, wireless data signals, or other types of signals via the antenna, depending on the nature of the mobile device 200. Further, in some configurations, the GPS sensor 238 may also make use of the antenna to receive GPS signals.

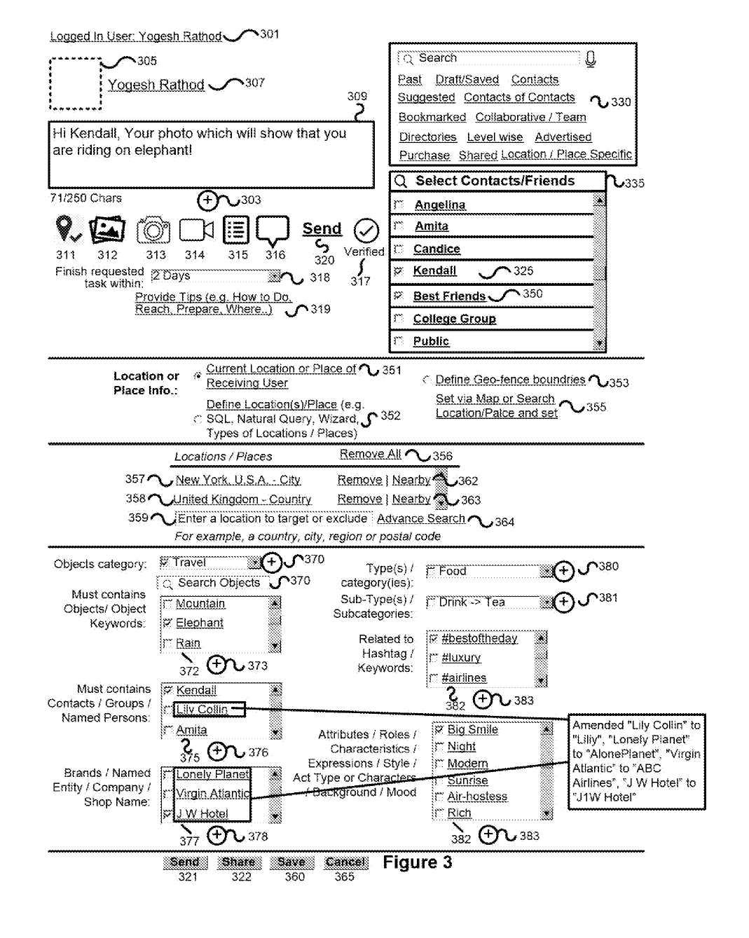

FIG. 3 illustrates example Graphical User Interface (GUI) 270 for enabling user to prepare and draft message or request or suggestion or defining task 309 for assigning task or instructing task to fulfill or requesting or suggesting to do particular task wherein task comprise ask or instruct or challenge to capture photo or record video as per said message or request or suggestion or defined or described task and associated one or more rules and settings including finish said message or request or suggestion associated described task within pre-set duration 318. In an embodiment message may in the form of text, location, web address or link, keywords, categories, hashtags, metadata, photo, video, structured data, and any combination thereof, wherein user can select one or more photos or videos voice files 312, location 311 or capture or record one or more photos 313 or videos 314, search, match, import, select from one or more types of list of messages or templates 315/330 including past sent list of messages, select message from locally saved or draft messages, select messages sent by contacts or contacts of contacts of user, search and select messages or templates of messages from directories and sent or prepared by other users of network or providers, select from bookmarked, advertised messages or templates of messages, select from displayed suggested list of messages or templates of messages, wherein suggested messages or templates of messages displayed based on users or selected contacts 325 associated one or more types of user data including one or more types of user profile including job profile, business profile, professional profile, general profile, game profile, past or current locations, places, one or more types of logged activities, actions, events, transactions, status, behaviours, communications, sharing, sent or received messages and associated one or more types of contents including photos or videos and scores. In an embodiment user can ask or take help of one or more other users of network or contacts of user or team members of particular team to prepare message or instruction or request or define task via chat or instant messenger or collaborative application or dedicated Graphical User Interface (GUI) 316. In an embodiment user can ask or hire service provider to prepare message or instruction or task as per user's requirements or enabling user to purchase set of message or instruction or task templates from 3^{rd} parties' providers or developers of message or instruction or task templates. After preparing message or instruction or suggestion or task user can select one or more contacts, connections, followers, groups, networks, team from list of contacts, contacts of contacts, connections of one or more social networks, followers, networks, team as target recipients of said prepared message 309 or make said message or instruction or defined task 309 available or searchable for public or ask in public to finish or fulfill or do said message or instruction 309 associated defined or described task 309. In an embodiment enable user to define and configure target recipients based on query, types, SQL (structured query language), selected one or more keywords and categories, locations, profile fields including age or age range, type of gender, education, skills, locations, income range, interest or hobby types, related type of or named entities including school, college, company, organization, club, division, class, and position, associated one or more types of one or more conditions, criteria, rules, filters, metadata and boolean operators and any combination thereof. In an embodiment message may comprises a text, a location information, a photo, a video, a voice, a link or web address, a keyword or hashtag and associated metadata including date & time of creation and sent, message sender photo, identity and link of profile, identities of one or more selected contacts as target recipients of message, keywords, hashtags, tags, rules including pre-set duration within which message receiver has to finish task defined in message, preferences and settings and any combination thereof. For example User [Yogesh Rathod] 307 prepares message “Hi Kendall, Your photo which will show that you are riding on elephant!” 309 and selects contact [Kendall] 325 and group [Best Friends] 350 as target recipients of said message 309 to send said prepared message 309 to said selected contact 325 and each group members 350 via server module 151 of server 110 to assign or instruct or suggest or request to fulfill or finish or complete or to-do said message or instruction or suggestion or request associated defined or described task including capture one or more photos or record one or more videos as per said message or instruction or suggestion or request associated defined or described task within said pre-set duration 318. In an embodiment user can prepare or create or define structured message or instruction or task or request or suggestion by using or employing or filling structured form or fields, wherein structured fields may comprise one or more types or categories 370 of searched 370 or selected objects 372, current locations of each target recipients 351, defined locations and places 352, one or more types of locations or places 352, defined radius or geofenced around current location or place of each target recipients 353, selected or searched or set location(s) or place(s) on map 355, included 357/358 and excluded 359 or nearby 362/363 one or more locations or places (location may comprise address, country, state, city, area, pin, suburb, point of interest, place name), type and named one or more contacts or groups 375 or entities 377 including school, college, restaurant, shop, mall, club, product, brand, and company name, one or more types or categories or sub-categories 380/381 or hashtags or keywords or tags 382 of photo or video and any combination thereof. For example user selects object category [Travel] 370 and selects objects [Elephant] 372 and selects contact name [Kendall] 375 and selects entity name [J W Hotel] and selects hashtag [#bestoftheday] and send 320/321 said structured message to selected contact

[Kendall] 325. So as per structured message user [Kendall] need to capture photo or record video which must or should or may contains said objects [Elephant] 372, person (himself) [Kendall] and hotel [J W Hotel] in said captured photo or recorded video and may related to or logically relevant hashtag [#bestoftheday]. In an embodiment user can prepare message in editor or free form 309 or structured or in combination of both freeform and structured. In an embodiment user can save message 309 locally or save remotely 360. In an embodiment user can share 322 message with one or more contacts, connections of one or more social networks, groups, networks or in public or make them searchable or accessible for other users of network. In an embodiment user can cancel 365 prepared or drafted message 309. In an embodiment user can provide one or more tips 319 with message to facilitating message recipients in fulfilling message associated task or instruction, wherein tips may include recipe, information, how to do details, help, location or place name and address, one or more related persons or contact names, tutor, video, photo, web address, application, website name, one or more products and services names, source (shops, online e-commerce websites) and addresses, map, route & directions, costs or prices, ticket(s) sources and availabilities.

In an embodiment server module 151 receives message from user and processes the message, wherein process may include grammar verification, spell check, detect language as per defined rules and policies, duplicate content, junk characters, length of message, automatically recognizing and reporting spam, inappropriate, and abusive messages system and human mediated recognizing and reporting spam, inappropriate, and abusive messages as per rules, keywords and policies, verify image or images of video to identify spam or inappropriate message, associate metadata and system data. In an embodiment server module 151 may employ a moderation system to sort messages that are irrelevant, obscene, illegal, or insulting and may also employ content moderators to manually inspect or remove content flagged for hate speech or other objectionable content. These moderators are given special privileges to delete or edit others' messages and/or remove, block, suspend user account or warning user to ensure that the messages or shared content complies with legal and regulatory exigencies, site/community guidelines, and user agreements. In an embodiment spontaneous moderation may employ wherein users will spontaneously moderate their peers through viewing, assessing and alerting message sender. Common privileges of moderators include deleting, merging, moving, and splitting of messages, locking, renaming, banning, suspending, unsuspending, unbanning, warning the members, or adding, editing, removing the messages. In an embodiment server module 151 may employ a wordfilter or Content-control software or filter or censor system which contains a script that automatically scans users' messages and shared or send or published contents as they are submitted and automatically changes or censors particular words or phrases. The most basic wordfilters search only for specific strings of letters, and remove or overwrite them regardless of their context. More advanced wordfilters make some exceptions for context (such as filtering “butt” but not “butter”), and the most advanced wordfilters may use regular expressions. In an embodiment server module 151 receives message from user and checks, verifies, and validates received message by employing message verification, reviewing, analyzing technologies and human mediated review, verification, checking and validation to identify whether message is spam, inappropriate, inappropriate as per pre-defined rules, policies and take one or more actions and reactions on it, wherein reactions comprises mark as spam and inappropriate and actions comprises instruct system or server module 151 to do not send said message to message associated target recipients defined and selected by sender of said message, remove or block or delete or suspend account of said message sender user. In an embodiment user can prepare message 309 and first verify 317 the message 309 and then can send 320 message 309 to one or more selected target recipients 335, so in the event of unintentionally inappropriate message found then user can able to edit and again verify and then send the message to avoid mark as spam or inappropriate or abuse or avoid blocking of sending of message to target recipients or avoid removing or suspending or blocking of user's account temporarily or permanently.

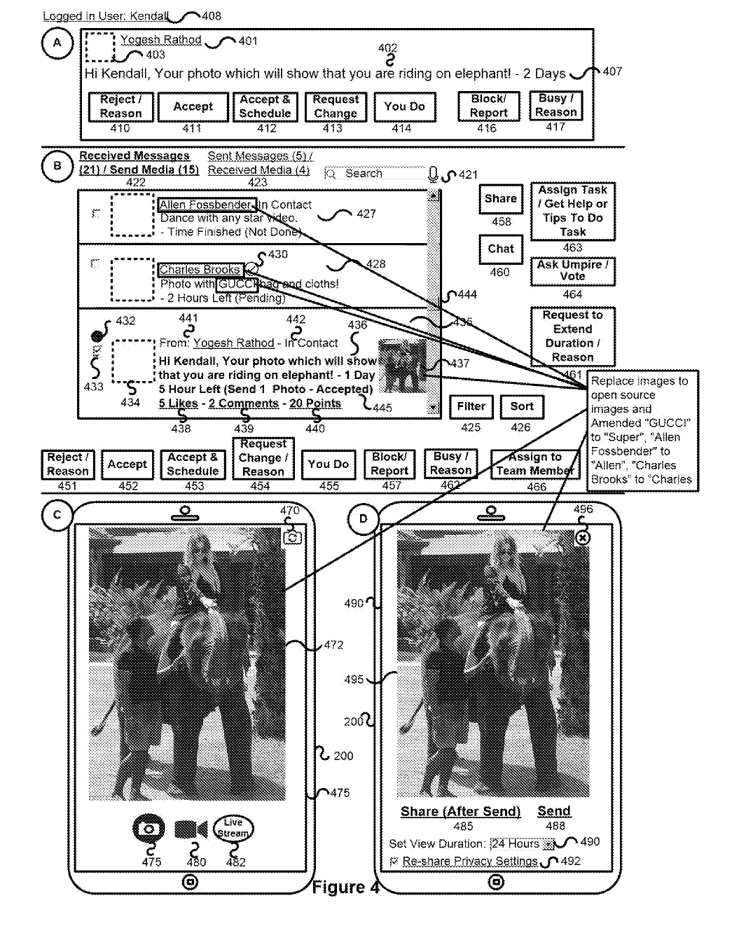

After successfully processing and verifying of message, server module 151 prepares and generates message notification for each target recipient of message and sends notification and message, associated metadata, rules and call-to-action or action controls to each target recipient via one or more types of notification system and channels including push notification. FIG. 4 (A) illustrates example Graphical User Interface (GUI) 271 for enabling each target recipient to view said received notification including message 402 and associated metadata including sender photo, name and profile link 401 and rules including duration 407 within which user need to finish message associated task to get points and take associated one or more user actions or call-to-actions including accept 411 message 402 or message associated task or instruction or suggestion or request 402 including as per message capture instructed or suggested or challenged or requested particular type of photo or record video 402, reject message associated task 410 or reject message associated task with selected or provided one or more reasons 410, accept message associated task and provide start and end schedule 412 of task as per pre-set duration to finish task associated with message, request sender to change or update message 413 or chat with message sender to converse regarding change or update of message, instead of accept message, ask or instruct message sender to do message associated task 414, in the event of message sender is anonymous and receiving user found message as spam or inappropriate or abusive then receiving user can report as spam or inappropriate or abusive 416 to server module 151 and block or remove user 416. In an embodiment user can provide user's status including busy, not available for particular days with one or more types of selected or provided and reasons 417.

FIG. 4 (B) illustrates example Graphical User Interface (GUI) 271 shows received 422 and send 423 lists of messages or instructions or suggestions or requests to do particular or defined or described one or more tasks including capture one or more photos and record videos based on received message or instruction or suggestion or request. In the event of click or tap on “Received” tab 422, user can view received messages or instructions or suggestions or requests. In an embodiment user can select particular received messages or instructions or suggestions or requests 435 from list of messages or instructions or suggestions or requests 444 and can accept 452 message 435 or message associated task or instruction or suggestion or request 435 including as per message capture instructed or suggested or challenged or requested particular type of photo or record video 435, reject message associated task 451 or reject message associated task with selected or provided one or more reasons 451, accept message associated task and provide start and end schedule 453 of task as per pre-set duration to finish task associated with message, request sender to change or update message 454 or chat with message sender to converse regarding change or update of message, instead of accept message, ask or instruct message sender to do message associated task 455, in the event of message sender is anonymous and receiving user found message as spam or inappropriate or abusive then receiving user can report as spam or inappropriate or abusive 457 to server module 151 and block or remove user 457. In an embodiment user can provide user's status including busy, not available for particular days with one or more types of selected or provided and reasons 462.

In an embodiment in the event of selection of particular received and accepted message 435, FIG. 4 (C) illustrates example Graphical User Interface (GUI) 271 shows automatically displaying camera application 475 to enabling receiving user's (e.g. “Kendall”) computing device 200 to capture photo by clicking or trapping on “Photo” button or icon or control 475 or record video by clicking or trapping on “Video” button or icon or control 480 or take one or more types of media (e.g. Video Stream by clicking or trapping on “Video Stream” button or icon or control 482). User can switch front or back camera by clicking or trapping on button or icon or control 470. In an embodiment in the event of capturing of photo by clicking or trapping on “Photo” button or icon or control 475 or recording of video by clicking or trapping on “Video” button or icon or control 480 or taking one or more types of media (e.g. Video Stream by clicking or trapping on “Video Stream” button or icon or control 482), automatically associating or relating said captured photo or recorded video or media 472 with said accepted or selected message 435. In an embodiment FIG. 4 (D) illustrates example Graphical User Interface (GUI) 271 enabling user to previewing said captured photo or recorded video or media and can in the event of not found proper further or again capture photo or record video or take media or if user found captured photo or recorded video or media is proper then user can share, send or save said captured photo or recorded video or media. In the event of tapping or clicking on “Send” button or icon or control 488, receiving, by the server module 152, instruction to send, from the user's (e.g. “Kendall”) of the computing device 200, generating a message and receiving, from a computing device 200 of the user (e.g. “Kendall”), a message for sending to message sender (e.g. “Yogesh Rathod”), wherein message comprise said captured photo or recorded video or media 495 and associated metadata including message identity, instruction or request or suggestion or task message sender identity (e.g. “Yogesh Rathod”), exchangeable image file format (EXIF) data, location information, date & time of captured photo or recorded video, captured photo or recorded video message sender identity (e.g. “Kendall”) and receiver identity (e.g. “Yogesh Rathod”) and system data. In an embodiment based on said captured photo or recorded video message associated metadata identifying, by the server module 152, the sender of message as recipient of the message.

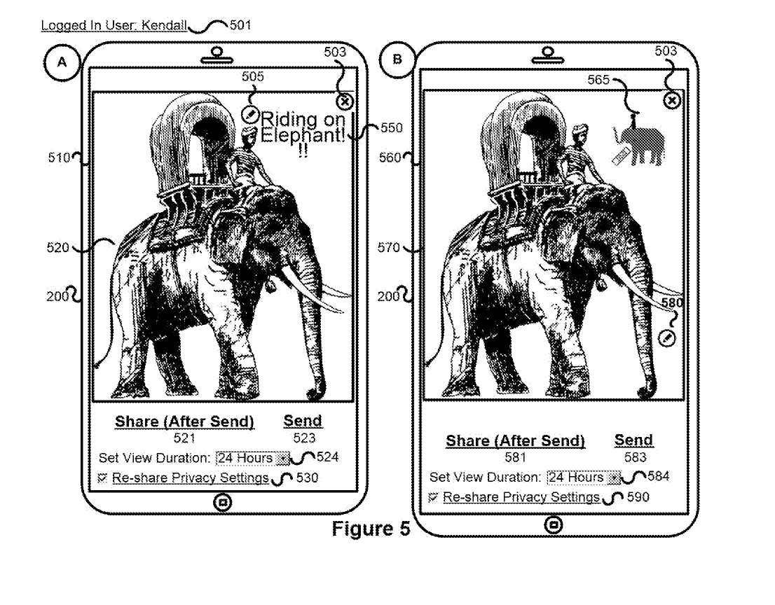

In an another embodiment in the event of selection of particular received and accepted message 435, automatically displaying camera application 475 to enabling receiving user's (e.g. “Kendall”) computing device 200 to capture photo by clicking or trapping on “Photo” button or icon or control 475 or record video by clicking or trapping on “Video” button or icon or control 480 or take one or more types of media (e.g. Video Stream by clicking or trapping on “Video Stream” button or icon or control 482). User can switch front or back camera by clicking or trapping on button or icon or control 470. In an embodiment in the event of capturing of photo by clicking or trapping on “Photo” button or icon or control 475 or recording of video by clicking or trapping on “Video” button or icon or control 480 or taking one or more types of media (e.g. Video Stream by clicking or trapping on “Video Stream” button or icon or control 482), FIG. 5 illustrates example Graphical User Interface (GUI) 271 shows previewing of said captured photo or recorded video or media 520 and enabling user (e.g. “Kendall”) to manually selecting, editing, preparing and integrating or merging or attaching or embedding or overlay said accepted or selected message 435 or part of message or edited message 435/505 (“Riding on elephant!!!”) or user provided or selected or applied text or one or more images or geo-filters or one or more types of multimedia 550 with/on/in/within/inside/overlay on or anywhere on said captured photo or recorded video or series of all or particular one or more images of video) or media 520. In an another embodiment in the event of capturing of photo 472 by clicking or trapping on “Photo” button or icon or control 475 or recording of video by clicking or trapping on “Video” button or icon or control 480 or taking one or more types of media (e.g. Video Stream by clicking or trapping on “Video Stream” button or icon or control 482), and automatically selecting or determining or generating or preparing and automatically integrating or merging or attaching or embedding or overlay said accepted or selected message 435 or automatically determined part of message 550 or automatically edited or updated message 435/550 (“Riding on elephant!! !”) or automatically determined or selected or applied text 550 or one or more images 550 or geo-filters 565 or one or more types of multimedia 565 with/on/in/within/inside/overlay on or anywhere on said captured photo or recorded video or series of all or particular one or more images of video) or media 520/570 and enabling user (e.g. “Kendall”) to preview said integrated or merged photo or recorded video or media 520/570. In the event of tapping or clicking on “Send” button or icon or control 523, receiving, by the server module 152, instruction to send, from the user's (e.g. “Kendall”) of the computing device 200, generating a message and receiving, from a computing device 200 of the user (e.g. “Kendall”), a message for sending to message sender (e.g. “Yogesh Rathod”), wherein message comprise said captured photo or recorded video or media 520 and associated metadata including message identity, instruction or request or suggestion or task message sender identity (e.g. “Yogesh Rathod”), exchangeable image file format (EXIF) data, location information, date & time of captured photo or recorded video, captured photo or recorded video message sender identity (e.g. “Kendall”) and receiver identity (e.g. “Yogesh Rathod”) and system data. In an embodiment based on said captured photo or recorded video message associated metadata identifying, by the server module 152, the sender of message as recipient of the message.

In an embodiment enabling user to search 421 messages based on one or more keywords, conditions, rules, Boolean operators and filters. In an embodiment user can filter 425 or sort 426 received messages based on user name or identities, status including received, accepted, not accepted, scheduled, instructed to sender of message to do message associated task, task pending, task done and accepted by task provider or instructor, task not done, pending to accept sent photo or video as per message associated task or instruction, umpire pending decision, duration left to finish task, date & time of receiving of messages, highest reactions received, new reactions received, ranks, contacts type, contact rank, type of media received, online or offline status, one or more members of particular named team or team name, ascending or descending order and any combination thereof.

In an embodiment user can preview said captured photo or recorded video or media and can in the event of not found proper further or again capture photo or record video or take media or if user found captured photo or recorded video or media is proper then user can share, send or save said captured photo or recorded video or media. In an embodiment in the event of tapping or clicking on “Send” button or icon or control 488, receiving, by the server module 152, instruction to send, from the user's (e.g. “Kendall”) of the computing device 200, generating a message 495 and receiving, from a computing device 200 of the user (e.g. “Kendall”), a message 495 for sending to message sender (e.g. “Yogesh Rathod”), wherein message comprise said captured photo or recorded video or media 495 and associated metadata including message identity, instruction or request or suggestion or task message sender identity (e.g. “Yogesh Rathod”), exchangeable image file format (EXIF) data, location information, date & time of captured photo or recorded video, captured photo or recorded video message sender identity (e.g. “Kendall”) and receiver identity (e.g. “Yogesh Rathod”) and system data. In an embodiment based on said captured photo or recorded video message associated metadata identifying, by the server module 152, the sender of message as recipient of the message. In an embodiment after sending of photo or video or media 495 or 520, enabling user to share 485/521 said photo or video or media 495 or 520 to one or more contacts, groups, one or more types of destinations including one or more types of one or more social networks, applications, services, websites, web pages, albums, stories, timelines and feeds. In an embodiment enabling user to set view duration 490 for enabling receiving user of said photo or video or media 495 or 520 message for said pre-set view duration only after receiving of message. In an embodiment enabling user to allow or not allow 492/530 to re-share said photo or video or media 495 or 520 message to all or one or more selected contacts, groups, networks, pre-defined types of users of network, public and users of one or more websites, applications and networks. In an embodiment enabling user to preview and cancel or remove 496/503 previewed or captured photo or recorded video or media 495/520.

In an embodiment enabling user to select one or more messages and share 458 messages or one or more selected messages associated one or more photo s or videos or media or one or more types of contents 437 to one or more selected contacts, groups, one or more types of destinations including one or more types of one or more social networks, applications, services, websites, web pages, albums, stories, timelines and feeds.

In an embodiment enabling user to chat or instant messenger or email or conduct one or more types of communication 460 with task or instruction message specific photo or video or media sender user.

In an embodiment enabling user to assign received message associated instruction or task 463 to one or more contacts or other users of network or paid service providers. In an embodiment enabling user to assign received message associated instruction or task 463 to one or more contacts or other users of network or paid service providers with permission or authorization from instruction or task message sender or preset settings of instruction or task message sender and/or server 110 administrator or based on default or user specific settings of server 110.

In an embodiment in the event of rejection of send instruction or task message specific one or more photos or videos or media, enabling user to ask appointed umpire 464 or ask paid service provider or umpire 464 or as per pre-set rules or mutual permissions take vote 464 from mutual or common or pre-defined set of contacts of instruction or task message sender and instruction or task message specific one or more photos or videos or media sender or other users of network.

In an embodiment enabling user to request instruction or task message sender to extend or provide additional duration 461 to finish said message associated task and provide one or more reasons to need of extension of time to finish message associated task.

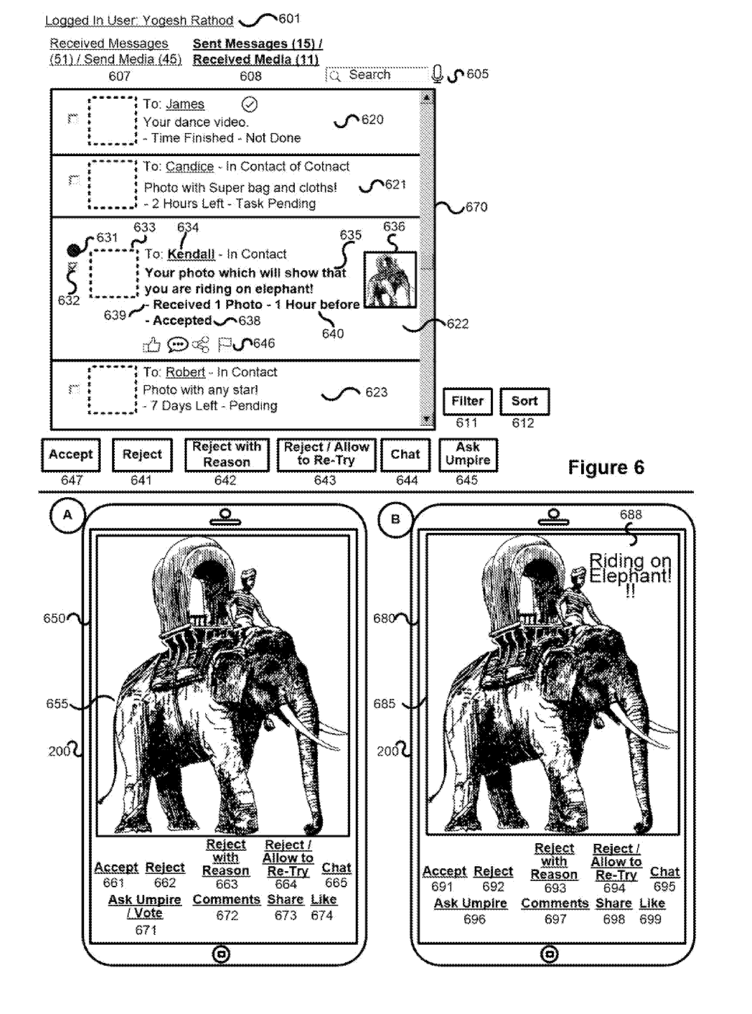

In an embodiment sending and notifying 622, by the server module 152, said captured photo or recorded video or media message 495 to the instruction or task or suggestion or request message sender (e.g. “Yogesh Rathod”). FIG. 6 illustrates example Graphical User Interface (GUI) 273 showing said received captured photo or recorded video or media message 622 or updating and displaying instruction or task message with received captured photo or recorded video or media message, status, reactions controls and reactions and metadata 622 to the instruction or task or suggestion or request message 309 sender (e.g. “Yogesh Rathod”). In the event of clicking or tapping on message (e.g. message 622) from list of received message 670 by receiving or viewing user (e.g. “Yogesh Rathod”), displaying message associated one or more photos 655 or videos or media or any combination thereof, wherein message may comprises message sender photo 633, name and profile link 634, status and type of message send 637, instruction or task or request or suggestion message sender name and associated instruction or task or request or suggestion message 635, number and type of media received 639, sending date & time 640, status 638 associated with instruction or task or request or suggestion message 309 sent by user (e.g. “Yogesh Rathod”), thumbnail of received photo or video or media 636 send by instruction or task doer user (e.g. “Kendall”), one or more type of reaction controls 646 for enabling receiving or viewing user to take one or more actions and reactions including like, dislike, comment, share, report.

FIG. 6 (A) illustrates example Graphical User Interface (GUI) 273 showing, in an embodiment in the event of clicking or tapping on list item e.g. 622, displaying particular selected sent instruction or task message specific received media 655 and enabling receiving or viewing user (e.g. “Yogesh Rathod”) to review displayed photo or video or media 655 and can take one or more actions or reactions on it, wherein actions or reactions comprises accept 661 said displayed photo or video or media 655, reject 662 said displayed photo or video or media 655, reject said displayed photo or video or media 655 and provide reasons 663, reject displayed photo or video or media 655 and allow to retry 664 to resend said instruction or task message 309 specific photo or video or media, chat 665 with photo or video or media 655 sender (e.g. “Kendall”), in the event of found difficulty in taking decision whether displayed photo or video or media 655 is/are as per instruction or task message 309 send by user (e.g. “Yogesh Rathod”) to target recipient (e.g. “Kendall”) or not then user (e.g. “Yogesh Rathod”) enable to take the help of umpire or ask the umpire to provide decision 671, provide one or more types of reactions including provide comments 672 on displayed photo or video or media 655, if appropriate permission of sender provided then share or share after acceptance 673 said displayed photo or video or media 655 to one or more contacts, groups, one or more types of destinations including one or more social networks, search engines, websites, webpages, applications, services, timelines, feeds, albums and stories, like, dislike, ratings or provide one or more types of emoticons on said displayed photo or video or media 655, provide one or more tags, hashtags, keywords. Server module 152 receives and notifies said one or more types of status including accepted, not accepted, rejected with reason, reject and allow to retry, asked umpire, waiting for umpire decision, accepted by umpire, rejected by umpire and time finished & task not done and reactions including liked, shared, commented to instruction or task message specific media sender user (e.g. “Kendall”).

FIG. 6 (B) illustrates example Graphical User Interface (GUI) 273 showing, in an embodiment in the event of clicking or tapping on list item e.g. 622, displaying particular selected sent instruction or task message specific received media 685 and enabling receiving or viewing user (e.g. “Yogesh Rathod”) to review displayed photo or video or media 685 which also shows integrated, merged, combined, embed or overlay message or part of message or text or image or one or more types of multimedia or geo-filters 688 prepared, selected and applied by user or automatically generated or automatically determined or automatically selected or automatically applied by server or server administrator and enabling to take one or more actions or reactions on it, wherein actions or reactions may comprises accept 691 said displayed photo or video or media 685, reject 692 said displayed photo or video or media 685, reject said displayed photo or video or media 695 and provide reasons 693, reject displayed photo or video or media 685 and allow to retry 694 to resend said instruction or task message 309 specific photo or video or media, chat 695 with photo or video or media 685 sender (e.g. “Kendall”), in the event of found difficulty in taking decision whether displayed photo or video or media 685 is/are as per instruction or task message 309 send by user (e.g. “Yogesh Rathod”) to target recipient (e.g. “Kendall”) or not then user (e.g. “Yogesh Rathod”) enable to take the help of umpire or ask the umpire to provide decision 696, provide one or more types of reactions including provide comments 697 on displayed photo or video or media 685, if appropriate permission of sender provided then share 698 said displayed photo or video or media 685 to one or more contacts, groups, one or more types of destinations including one or more social networks, search engines, websites, webpages, applications, services, timelines, feeds, albums and stories, like, dislike, ratings or provide one or more types of emoticons on said displayed photo or video or media 685, provide one or more tags, hashtags, keywords.

In an embodiment user can filter 611 or sort 612 sent instruction or task messages and/or received instruction or task messages specific one or more types of contents or media including one or more photos and videos, wherein filters or sort types may comprises user name, user identity, sent instruction or task messages accepted or rejected or rejected with reason or scheduled or request change or ask user to do message associated task or busy, type of contact, rank of contact, date & time of sending of messages, instruction or task messages receiver's status including task pending, task done, task not done within pre-set duration set by instruction or task message sender, type of media received, instruction or task messages specific one or more types of contents or media accepted or rejected or rejected with reason or reject and allow to retry or asked umpire by user or pending for umpire decision, type of reactions including liked, commented, shared, online or offline status and any combination thereof.

In an embodiment employing human mediation review and/or object recognition, human face and body parts recognition, voice recognition, Optical Characters Recognition, Pattern Matching technologies to match instruction or task message associated keywords with recognized objects in received instruction or task message specific media including one or more photos and videos (series of images) associated keywords to identify, verify, validate and check whether received instruction or task message specific media are as per provided instruction or task message or not.

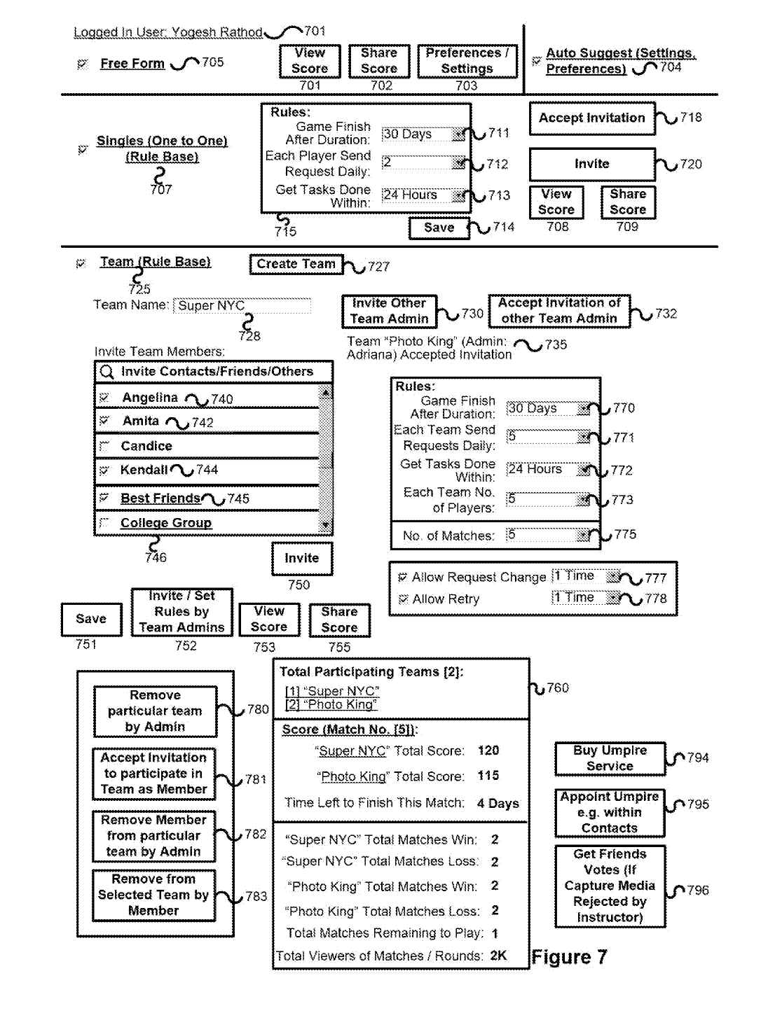

FIG. 7 illustrates example Graphical User Interface (GUI) 274 wherein user can select “Free Form” option 705 to get instruction or task message from one or more contacts, contacts of contacts, advertisers, users of network based on preferences, rules and settings 703, wherein preferences, rules and settings comprises selected one or more contacts, connections of one or more social networks and applications, groups, networks, any users of network or public, keywords and categories specific users including users from particular location(s), named school or college or type or named interacted or related one or more entities, all or preferences specific verified users, all or preferences specific advertisers including advertisers who provides offers including cash, gifts, redeemable points, vouchers, cashbacks, discount, samples, digital goods, and points, pre-set scheduled date and time or pre-set duration for receiving instruction or task message, receiving instruction or task message from mutually connected users or invitation accepted users only. User can view score 701 and share score 702. User can accumulate or collect or aggregate score as much as possible for ranking, showcase in ladder.

In an embodiment automatically get instruction or task messages from server based on preferences including interests types, categories, keywords, hashtags, named or type of or pre-set locations and places, defined geofenced boundaries, defined radius surround user's current location or particular locations or places, date & times and one or more types of filters, conditions, SQL (Structured Query Language) and criteria, rules including receiving instruction or task message as per pre-set scheduled date and time or pre-set duration and settings 704 of user and/or advertisements or suggested by server or picked by server administrators and/or one or more types of user data, wherein user data comprises current or past locations, checked-in places, current date and time and associated events, schedules, place associated information, date associated events or festivals, accompanied contacts and associated user data, logged various types of information about current and past activities, actions, events, transactions, interacted entities, calendar entries, user contacts and connection and associated user data, one or more types of profile including general profile comprises age, gender, income range, interests or hobbies, current and past work and office addresses, related one or more types of entities, related keywords, tags, hashtags, related reactions, liked products, services, people and entities, job profile, social profile, interests profile, professional profile, business profile and like.

In an embodiment enabling user to select “Singles” option 707 wherein user can accept invitation 718 of contacts or other users of network and send invitation 720 to contacts or other users of network and in the event of acceptance of invitation enable both mutually connected users to send each other instruction or task messages and receive associated or related media from each other based on one or more types of mutually decided rules and settings, wherein rules and settings 715 comprises finish game within pre-set duration 711, daily allowed pre-set number of instruction or task messages sending 712 and get message associated task done within pre-set duration 713 and then user can save and execute or apply rules and settings 714. So user can play with each mutually connected user with mutually decided rules and settings with each mutually connected user. User can view score 708 and share score 709.

In an embodiment user can select Team option 725 and create and manage one or more teams. In the intention to become administrator of particular team, user can tap or click on “create team” button 727 and provide team name e.g. “Super NYC” 728 and invite other team administrator 730 (e.g. “Team “Photo King” (Admin: Adriana) Accepted Invitation”) or accept invitation of other team administrator 732 with the intention to challenge said team. After that both team or each participated team can invite team members by selecting one or more contacts, groups or other searched or matched users of network (e.g. 740, 742, 744 and 745) from list of contacts, groups and other users of network 746 and sending invitation to each team members 750. Team administrators can mutually decide rules and settings 752 to be applied to both teams, wherein rules and settings comprises finish game within pre-set duration 770, daily allowed pre-set number of instruction or task messages sending by each team to other team 771 and get message associated task done within pre-set duration 772, number of players in each team 773, number of matches 775, allowed number of times request or instruction or task message changes 777, allowed number of times retry 778. In an embodiment while creating team some validation may apply, wherein validation comprises no more than pre-set number of players, no same member in both team, at least 2 members in each team. After creating team and deciding and applying rules team administrators can finalize and save team and associated rules and settings 751. In an embodiment administrator of team can remove team 780. In an embodiment administrator of team can remove one or more team members from team 782. In an embodiment user can view and accept invitation of particular team administrator 781 with the intention to participate in said team. In an embodiment any team member can remove themselves from particular team 783. In an embodiment enabling user to buy or hire umpire service 794, enable team administrator or mutually connected users to mutually appoint umpire from contacts or other users of network 795, and in the event of conflict and as per mutually decide, gets friends votes 796. In an embodiment team members and based on mutual permission, contacts or other users of network can view scores 753. In an embodiment team administrator or as per mutual decision team administrators can view or publish or share team information, associated updated scores, status, statistics, analytics, logged activities 760 to feeds, timelines, and one or more contacts, groups, networks, external social networks, websites, applications, web services, and one or more types of digital destinations. In an embodiment if tie between two teams then pre-set number of (e.g. 5) more attempts for each team. If again tie between two teams then each team gets 1 attempt up-to 1 team fails. In an embodiment provide pre-set particular number of points for acceptance of instruction or task specific one or more types of contents or media including one or more photos or videos. In an embodiment deduct pre-set particular number of points for rejection or rejection after allowing retry of instruction or task specific one or more types of contents or media including one or more photos or videos. In an embodiment provide pre-set particular number of points for finishing particular number of the task of the assign task. In an embodiment assign more than one task by sending a message 309. In an embodiment user can view detail profile of contact user e.g. “Kendall”325 before sending message 309 to said contact, so user can properly customize or prepare instruction or task 309.

Server module 155 receives and stores invitations, accepted or rejected invitations, information about mutually connected players, information about created teams and associated participated members, scores, rules, preferences, settings, updates, logged activities, actins, events, transaction, status, statistics, and updated scores.

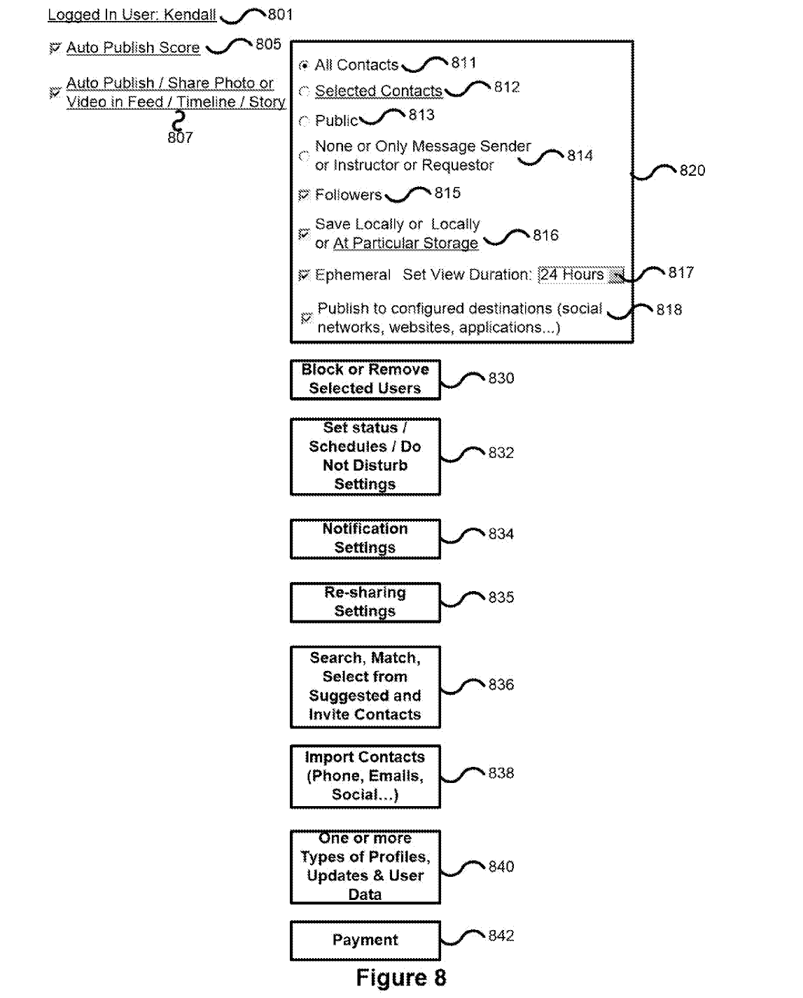

FIG. 8 illustrates example Graphical User Interface (GUI) 275 for enabling user to pre-set allowing to automatically publish or share or send or update scores 805 and automatically publish or share or send or update each or selected instruction or task message(s) and instruction or task message associated one or more types of content or media including one or more photos or videos, associated updated scores, number and types of views, number and types of reactions, logged one or more types of activities, actions, reactions including number of views, likes, types of emoticons, comments, shares 807 to all 811 or selected one or more contacts 812 or public 813 or None or do not publish or send to anybody or send only to message sender 814, followers 815, enabling to publish to said content to one or more social networks, search engines, websites, webpages, applications, web services, one or more selected users on external website's timeline or feed or profile, send via one or more communication channels, mediums and modes including email, phone, VOIP, SMS, Instant messenger, tweets and posts 818, save locally or at particular storage 816, and pre-set view duration for enabling receiving and viewing user to view said published content only for said pre-set view duration 817.

In an embodiment enabling user to block or remove selected contacts or users 830. In an embodiment enabling user to set status including online, offline, busy, not available and provide availability or non-availability one or more schedules and apply “Do Not Disturb” settings, rules and policies including allow to send instruction or task message only to selected contacts or users, availability or non-availability one or more schedules, ON or OFF “Do Not Disturb” 832. In an embodiment enabling user to provide or set or update one or more types of notification settings, wherein notification settings may include paly selected named and type of notification tones and vibration type while receiving of instruction or task message, while receiving of instruction or task message associated status, while sending of instruction or task message specific or related or associated one or more types of media inducing photo or video, while sending of instruction or task message specific or related or associated media or content related status, type of reactions 834. In an embodiment enabling user to allow or not allow one or more selected contacts or users or type of users to reshape user related, shared, published, generated contents, messages, shared media, status, and scores 835. Server module 157 receives stores and applies said one or more types of privacy settings related to each user of network. In an embodiment enabling user to search and match one or more contacts or users of network, view profile of searched or matched or suggested users of network and send invitations or accept invitation of other contacts or other users of network 836. In an embodiment enabling user to invite phone contacts via SMS or invite email contacts via emails or invite social network contacts or connections via sending posts or messages to one or more social networks, applications and websites and inviting them to download and install application and connect with user to play games including send and receive and accept or reject instructions or tasks, send and receive and accept or reject instruction or task specific media, create teams, invite contacts and participate in team, and view feeds including shared contents, status, reactions and scores 838. In an embodiment enabling user to provide one or more types of profile information, updates, updated status, checked in places, current location, interests, participated or participating events, conducted transaction details, liked activates, products, services, entities, and people, related keywords, hashtags, import, search and invite contacts 840. In an embodiment user is configured to provide one or more types of payment information 842.

In an embodiment in Team mode of play, team members and administrator can collaboratively 330 (“Collaborative/Team”) prepare instruction or task message 309 and can send to one or more target recipients or teams or selected member of selected team. In an embodiment administrator of team can assign received message associated task including capture said received message associated task related photo or recorded video and preview and send to particular selected team member 466. In an embodiment enabling administrator of team or member of team to accept or reject message associated instructed task. In an embodiment enabling administrator of team or message sending member of team to accept or reject message associated instructed task associated received one or more types of instructed content or media.

In an embodiment score my calculated based on how fast take task specific media. In an embodiment if instructed task finish then enabling to ask other task (task assigner user must have to provide task within particular duration e.g. within 10 minutes) and determine winner uses or team based on who finish more tasks within particular duration (e.g. 1 week). In an embodiment enabling user to search one or more team based on name, rank, score range, location, category, profile field and invite them and challenge them.

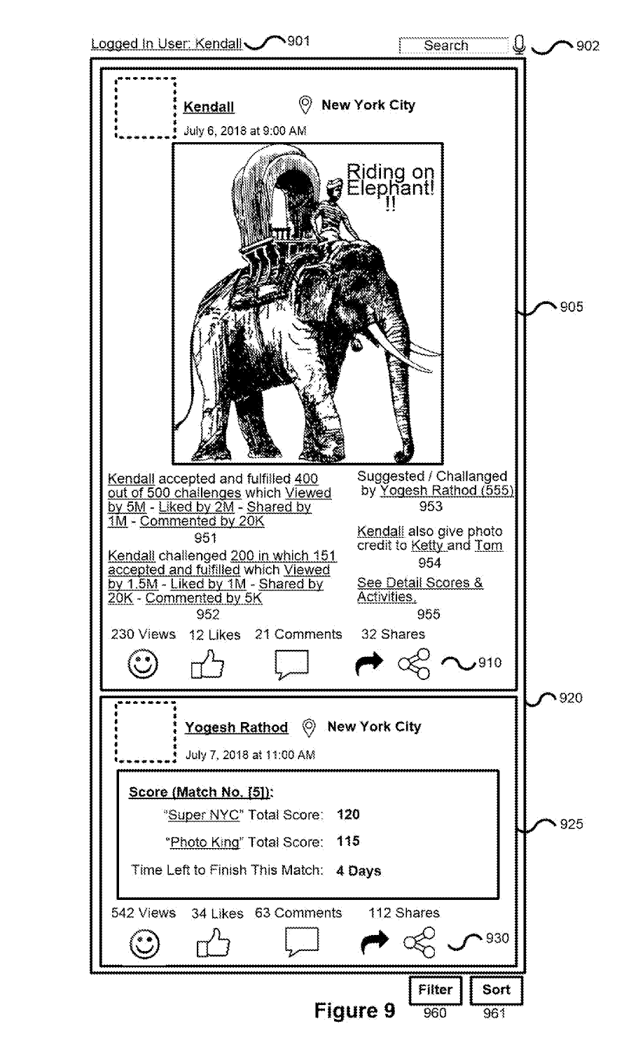

FIG. 9 illustrates example Feed Graphical User Interface (GUI) 276 wherein server module 156 generates feed item or news feed or feed post based on shared or posted or published or send task or instruction messages associated one or more types of contents or media including photo or video, associated or integrated full or part task or instruction message or image, associated metadata, reactions, and scores and serves to authorized or related or requested viewing users or feed or timeline, wherein feed items or feed posts comprises user's own 905 and other users' including connected users, current location or checked in place specific, logged preferences specific users' 925 shared, published and posted one or more types of contents or media including provided instructions or assigned tasks specific photos or videos and associated task message, scores, reactions, analytics and statistics. In an embodiment user can provide one or more types of reactions including like, provide comment on and take one or more types of actions including share displayed posts or one or more types of contents or media including provided instructions or assigned tasks specific photos or videos. In an embodiment user can view scores, statistics including total number of tasks accepted and total number of accepted tasks fulfilled, total number of likes, comments, shares, views, points and scores 951, total number of tasks assigned, total number of assigned tasks specific received media and associated, likes, comments, shares, views, points and scores 952. In an embodiment user can view from post detail scores 955. In an embodiment posting user can mention accessible user names and associated link, who help user in conducting of said assigned tasks. In an embodiment enabling user to search and match 902 feed items or feed posts or one or more type of contents published or share or send by user's contacts, participated or administrated team members, groups, networks, followed sources and users of network who shared or published posts or one or more type of contents or media including photos, videos associated task message, metadata, scores, reactions, statistics. In an embodiment enabling user to sort 961 and filter 960 displayed feed items or feed posts or one or more type of contents published or shares or send to user by user's contacts, groups, participated or administrated team members, networks, followed sources and users of network who shared or published posts or one or more type of contents or media including photos, videos associated task message, metadata, scores, reactions, statistics, wherein sort or filter types comprises sort or filter as per received date & time or ranges of received date & time, one or more sources or contact names or team names or group names or followed source, one or more locations or places or define radius surround current or particular location, highest to lowest views, scores and type of reactions, highest posts from sources, keywords found in instruction or tasks messages, keywords matched with recognized objects in photo or video (series of images) related keywords, keywords matched with metadata associated with posts or displayed one or more types of contents or media, integrated media with task message or part of message or image, ephemeral content only, type of media or content including photo or video, user's own published or posted or sent contents or media or posts and any combination thereof.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

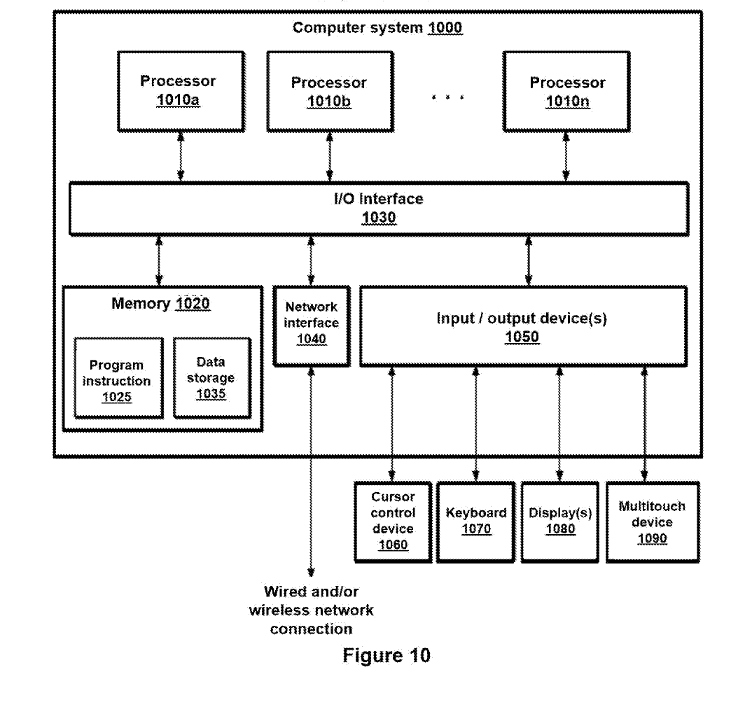

Various components of embodiments of methods as illustrated and described in the accompanying description may be executed on one or more computer systems, which may interact with various other devices. One such computer system is illustrated by FIG. 10. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 10, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program).A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method. Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

I claims:

1. The computer-implemented method comprising:
a) sending a task message and associated rules, settings, metadata and identity of sender, from a first computing device of a first user, to one or more target recipients including the second user of the second computing device;
b) displaying said task message to each said target recipient including the second user of the second computing device;
c) enabling the receiving user including the second user of the second computing device to select particular received and accepted task message;
d) in the event of selection of particular received and accepted task message, automatically displaying camera application to enabling receiving user including the second user of the second computing device to capture photo or record video or take one or more types of media;
e) in the event of capturing of photo or recording of video or taking one or more types of media, automatically associating or relating said captured photo or recorded video or media with said accepted or selected task message;
f) in the event of receiving instruction to send, from the second user of the second computing device, generating a message and receiving, from a second computing device of the second user, said generated message for sending to the task message sender, wherein message comprise said captured photo or recorded video or media and associated metadata and system data;
g) identifying, by a computer processor, the sender of message as recipient of the message;
h) sending said captured photo or recorded video or media to the first computing device of the first user or the message sender; and
i) displaying said captured photo or recorded video or media to the first computing device of the first user or the message sender.

2. The method according to claim 1 wherein in the event of capturing of photo or recording of video or taking one or more types of media, enabling to manually or automatically integrating or merging or attaching or embedding or overlay said accepted or selected message or part of message or edited message or user provided or selected or applied text or one or more images or geo-filters or one or more types of multimedia with/on/in/within/inside/overlay on said captured photo or recorded video or media.

3. The method according to claim 1 wherein instructing instructed user to send message within particular duration after instruction or task message specific capturing of photo or recording of video else cancel sending of said captured photo or recorded video to instruction or task message sender, wherein start timer and in the event of expiration of said started timer cancel said captured photo or recorded video for sending to message sender and display camera application to enable to further take or capture photo or record video.

4. The method according to claim 1 wherein enabling the receiving user including the second user of the second computing device to accept or reject the message.

5. The method according to claim 1 wherein identifying EXIF data in captured photo or recorded video including original date & time of captured photo or recorded video and match said extracted or identified original date & time with server date & time to validate or check or verify originality of captured photo or recorded video, wherein the game rules require the submitted photographic image or video or media to have an integrated and encrypted date stamp in the form of exchangeable image file format (EXIF) data which is matched with captures photo or image or recorded video or media date and time with server date and time.

6. The method according to claim 1 wherein enable message sender to accept or reject said received or displayed captured photo or recorded video.

7. The method according to claim 1 wherein rules comprise instruction to do particular task within particular duration, must capture at particular location or place, must capture at particular date and time or within particular range of date and time, must contains or includes or excludes particular one or more types or named objects, items, accessories, attributes, properties, characteristics, design, physical environment including sunset or sunrise, rain, sunrays, day or night or evening, buildings or infrastructure, trees, animals, birds, persons or entities, brands, logos, products and like.

8. The method according to claim 1 wherein recipients comprises all or one or more selected or included or excluded contacts, groups, networks, contacts of contacts, categories of users of network, particular team, particular team members, pre-defined or query or SQL (Structured Query Language) query based users of network, followers, phone contacts, e-mail addresses, social network accounts and any combination thereof.

9. The method according to claim 1 wherein enable message receiver to accept or reject message associate instruction or request to change instruction or instruct message sender to do message associate instruction or request to provide more duration to full-fill message associate task or instruction.

10. The method according to claim 1 wherein in the event of rejection of said received photo or recorded video, further instruct said photo or video sender to further send instructed photo or video based on provided or updated one or more rules including pre-set duration to finish instructed task including further send instructed photo or video within said pre-set duration.

11. The computer-implemented system comprises:
a) send a task message and associated rules, settings, metadata and identity of sender, from a first computing device of a first user, to one or more target recipients including the second user of the second computing device;
b) display said task message to each said target recipient including the second user of the second computing device;
c) enable the receiving user including the second user of the second computing device to select particular received and accepted task message;
d) in the event of selection of particular received and accepted task message, automatically display camera application to enable receiving user including the second user of the second computing device to capture photo or record video or take one or more types of media;
e) in the event of capturing of photo or recording of video or taking one or more types of media, automatically associate or relate said captured photo or recorded video or media with said accepted or selected task message;
f) in the event of receiving instruction to send, from the second user of the second computing device, generate a message and receive, from a second computing device of the second user, said generated message for sending to the task message sender, wherein message comprise said captured photo or recorded video or media and associated metadata and system data;
g) identify, by a computer processor, the sender of message as recipient of the message;
h) send said captured photo or recorded video or media to the first computing device of the first user or the message sender; and
i) display said captured photo or recorded video or media to the first computing device of the first user or the message sender.

12. The system according to claim 11 wherein in the event of capturing of photo or recording of video or taking one or more types of media, enable to manually or automatically integrate or merge or attach or embed or overlay said accepted or selected message or part of message or edited message or user provided or selected or applied text or one or more images or geo-filters or one or more types of multimedia with/on/in/within/inside/overlay on said captured photo or recorded video or media.

13. The system according to claim 11 wherein instruct instructed user to send message within particular duration after instruction or task message specific capturing of photo or recording of video else cancel sending of said captured photo or recorded video to instruction or task message sender, wherein start timer and in the event of expiration of said started timer cancel said captured photo or recorded video for sending to message sender and display camera application to enable to further take or capture photo or record video.

14. The system according to claim 11 wherein enable the receiving user including the second user of the second computing device to accept or reject the message.

15. The system according to claim 11 wherein identify EXIF data in captured photo or recorded video including original date & time of captured photo or recorded video and match said extracted or identified original date & time with server date & time to validate or check or verify originality of captured photo or recorded video, wherein the game rules require the submitted photographic image or video or media to have an integrated and encrypted date stamp in the form of exchangeable image file format (EXIF) data which is matched with captures photo or image or recorded video or media date and time with server date and time.

16. The system according to claim 11 wherein enable message sender to accept or reject said received or displayed captured photo or recorded video.

17. The system according to claim 11 wherein rules comprise instruction to do particular task within particular duration, must capture at particular location or place, must capture at particular date and time or within particular range of date and time, must contains or includes or excludes particular one or more types or named objects, items, accessories, attributes, properties, characteristics, design, physical environment including sunset or sunrise, rain, sunrays, day or night or evening, buildings or infrastructure, trees, animals, birds, persons or entities, brands, logos, products and like.

18. The system according to claim 11 wherein recipients comprises all or one or more selected or included or excluded contacts, groups, networks, contacts of contacts, categories of users of network, pre-defined or query or SQL (Structured Query Language) query based users of network, followers, phone contacts, e-mail addresses, social network accounts and any combination thereof.

19. The system according to claim 11 wherein enable message receiver to accept or reject message associate instruction or request to change instruction or instruct to do message associate instruction by message sender or request to provide more duration to full-fill message associate task or instruction.

20. The computer-implemented method comprising:
a) sending a task message and associated rules, settings, metadata and identity of sender, from a first computing device of a first user, to one or more target recipients including the second user of the second computing device;
b) displaying said task message to each said target recipient including the second user of the second computing device;
c) enabling the receiving user including the second user of the second computing device to select particular received and accepted task message;
d) in the event of selection of particular received and accepted task message, automatically displaying camera application to enabling receiving user including the second user of the second computing device to capture photo or record video or take one or more types of media;
e) in the event of capturing of photo or recording of video or taking one or more types of media, enabling to manually or automatically integrating or merging or attaching or embedding or overlay said accepted or selected message or part of message or edited message or user provided or selected or applied text or one or more images or geo-filters or one or more types of multimedia with/on/in/within/inside/overlay on said captured photo or recorded video or media;
f) in the event of receiving instruction to send, from the second user of the second computing device, generating a message and receiving, from a second computing device of the second user, said generated message for sending to the task message sender, wherein message comprise said captured photo or recorded video or media, integrated text or image or multimedia and associated metadata and system data;
g) identifying, by a computer processor, the sender of message as recipient of the message;
h) sending said captured photo or recorded video or media to the first computing device of the first user or the message sender; and
i) displaying said captured photo or recorded video or media to the first computing device of the first user or the message sender.
